(19) United States
(12) Patent Application Publication
(10) Pub. No.: US 2025/0360622 A1
(43) Pub. Date: Nov. 27, 2025

(54) METHOD FOR CONTROLLING A ROBOTIC APPARATUS

(71) Applicant: Robert Bosch GmbH, Stuttgart (DE)

(72) Inventors: Johannes Christian Mueller, Stuttgart (DE); Benjamin Voelz, Leonberg (DE); Christian Heinzemann, Vellmar (DE); Heiko Freienstein, Weil Der Stadt (DE); Jens Oehlerking, Stuttgart (DE); Joram Berger, Heimsheim (DE); Martin Herrmann, Korntal (DE); Martin Butz, Steinheim An Der Murr (DE); Michael Rittel, Markgroeningen (DE); Ralf Kohlhaas, Calw (DE); Steffen Knoop, Hohenwettersbach (DE); Wojciech Kleszcz, Krakow (PL)

(21) Appl. No.: 19/190,181

(22) Filed: Apr. 25, 2025

(30) Foreign Application Priority Data
May 27, 2024 (DE) 10 2024 204 857.7

(51) Int. Cl. B25J 9/16

(52) U.S. Cl. CPC B25J 9/1674; B25J 9/161

(57) ABSTRACT

A method for controlling a robotic apparatus. The method includes: detecting a control situation, ascertaining a set of assumptions about the control situation that underlie possible behaviors in the control situation; assessing the validity of at least some of the assumptions from the set of assumptions, restricting the set of assumptions to assumptions from the set of assumptions that have been assessed as valid; ascertaining one or more behaviors of the robotic apparatus in the control situation on the basis of the restricted set of assumptions; and controlling the robotic apparatus according to one of the ascertained behaviors.

### CROSS REFERENCE

The present application claims the benefit under 35 U.S.C. § 119 of German Patent Application No. DE 10 2024 204 857.7 filed on May 27, 2024, which is expressly incorporated herein by reference in its entirety.

### FIELD

The present invention relates to methods for controlling a robotic apparatus.

### BACKGROUND INFORMATION

When controlling a robotic apparatus in a control situation, there are risks of accidents, such as with other road users when controlling an at least partially automated vehicle in road traffic or with a human user who is near a robotic arm that is being controlled. Whether accidents occur can depend on various factors, in particular on the behavior of the other road users and whether the control situation was detected correctly. Accordingly, approaches are desirable that make it possible to keep the risk of accidents within a tolerable range when controlling a robotic apparatus.

According to various embodiments of the present invention, a method for controlling a robotic apparatus is provided, comprising detecting a control situation, ascertaining a set of assumptions about the control situation that underlie possible behaviors in the control situation, assessing the validity of at least some of the assumptions from the set of assumptions, restricting the set of assumptions to assumptions from the set of assumptions that have been assessed as valid, ascertaining one or more behaviors of the robotic apparatus in the control situation on the basis of the restricted set of assumptions, and controlling the robotic apparatus according to one of the ascertained behaviors.

The method described above makes it possible to control a robotic apparatus, e.g., to plan the movement (and corresponding control) of an at least partially automated vehicle, wherein extended safety guarantees can be given, i.e., a certain level of safety can be ensured not only by giving a formal guarantee given the assumptions, but also by limiting to an acceptable level the residual risk that the guarantees do not apply due to violated assumptions.

Various exemplary embodiments of the present invention are specified below.

Exemplary embodiment 1 is a method for controlling a robotic apparatus, as described above.

Exemplary embodiment 2 is a method according to exemplary embodiment 1, wherein at least one of the assumptions from the set of assumptions is an assumption about a behavior of another agent (another robotic apparatus, e.g., another autonomous vehicle, or a human or animal) in the control situation.

It is thus possible to take into account that another agent (e.g., another road user) does not follow the traffic rules.

Exemplary embodiment 3 is a method according to exemplary embodiment 1 or 2, wherein at least one of the assumptions from the set of assumptions is an assumption about a reliability of the detection of the control situation.

The reliability of a perception (e.g., object recognition or sensor data acquisition) can be taken into account thereby. For example, one or more plausibility and/or consistency tests are performed in order to determine the validity of assumptions with regard to the detection of the control situation.

Exemplary embodiment 4 is a method according to one of exemplary embodiments 1 to 3, comprising ascertaining a ranking of subsets of the set of assumptions, wherein, if at least one assumption from a first of the subsets has been assessed as invalid, the validity of the assumptions of one or more second of the subsets is assessed in an order given by the ranking, until a second subset of the set of assumptions has been found that contains only assumptions that have been assessed as valid (this second subset is then used as the restricted set of assumptions (or at least a part thereof)).

In other words, a degradation mechanism is provided according to which the assumptions are relaxed until assumptions that are assessed as valid are found. These assumptions are then used as the basis for the control. For example, if it cannot be assumed that another road user who does not have the right of way will stop, but it can be assumed that their speed has been correctly estimated so that no collision will occur if the intersection is crossed quickly, crossing the intersection quickly can be chosen as the behavior. For example, the individual subsets each contain multiple consistent assumptions.

Exemplary embodiment 5 is a method according to one of exemplary embodiments 1 to 4, wherein assessing the validity of each of the assumptions being assessed comprises ascertaining a probabilistic measure that the assumption is valid, and the assumption is assessed as valid if the probabilistic measure exceeds a specified threshold value.

It is thus possible to plan for a residual risk, which can be taken into account in the overall assessment of whether a behavior is safe. It should be noted that ascertaining a probabilistic measure that the assumption is not valid is the same as assessing the assumption as valid if the probabilistic measure does not exceed a specified threshold value. Exemplary embodiment 6 is a method according to exemplary embodiment 5, wherein the probabilistic measure is a subjective logic opinion or a belief measure according to the Dempster-Shafer theory or a probability.

By means of subjective logic, the epistemic uncertainty can be explicitly taken into account in the assessment. It is thus suitable for modeling and analyzing situations (in the present application, control situations) with uncertainty and unreliable sources (in the present application, for example, sensors, etc.). As an alternative to subjective logic, belief measures from the Dempster-Shafer theory or classical probabilities can also be used.

Exemplary embodiment 7 is a method according to one of exemplary embodiments 1 to 6, wherein the robotic apparatus is a vehicle, and the control situation is a traffic situation.

Exemplary embodiment 8 is a computer program comprising commands that, when executed by a processor, cause the processor to perform a method according to one of exemplary embodiments 1 to 6.

Exemplary embodiment 9 is a computer-readable medium storing commands that, when executed by a processor, cause the processor to perform a method according to one of exemplary embodiments 1 to 6.

In the figures, similar reference signs generally refer to the same parts throughout the various views. The figures are not necessarily true to scale, with emphasis instead generally being placed on the representation of certain principles of the present invention. In the following description, various aspects are described with reference to the figures.

### BRIEF DESCRIPTION OF THE DRAWINGS

FIG. 1 shows a vehicle, according to an example embodiment of the present invention.

FIG. 2 illustrates an example of a control method according to one example embodiment of the present invention.

FIG. 3 is a diagram illustrating the ascertainment of behaviors with monitoring of the validity of assumptions, according to an example embodiment of the present invention.

FIG. 4 illustrates a perception test performed by the ego vehicle, according to an example embodiment of the present invention.

FIG. 5 is a flowchart illustrating a method for controlling a robotic apparatus, according to an example embodiment of the present invention.

### DETAILED DESCRIPTION OF EXAMPLE EMBODIMENTS

The following detailed description relates to the figures, which show, by way of explanation, specific details and aspects of this disclosure in which the present invention can be executed. Other aspects may be used, and structural, logical, and electrical changes may be performed without departing from the scope of protection of the present invention. The various aspects of this disclosure are not necessarily mutually exclusive, since some aspects of this disclosure may be combined with one or more other aspects of this disclosure to form new aspects.

Various examples are described in more detail below.

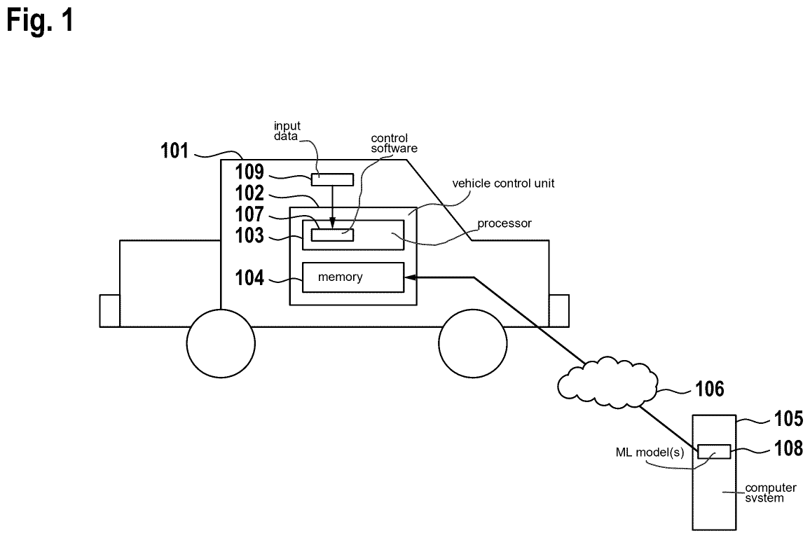

FIG. 1 shows a vehicle 101.

In the example of FIG. 1, a vehicle 101, for example a motor vehicle such as a passenger car or truck, is provided with a vehicle control unit (for example, an electronic control unit (ECU)) 102.

The vehicle control unit 102 comprises data processing components, for example a processor (for example, a CPU (central processing unit)) 103 and a memory 104 for storing control software 107, according to which the vehicle control unit 102 operates, and data that are processed by the processor 103. The processor 103 executes the control software 107.

For example, the stored control software (computer program) comprises instructions that, when executed by the processor, cause the processor 103 to execute driver assistance functions or even to control the vehicle autonomously.

The control software 107 is, for example, transmitted to the vehicle 101 from a computer system 105, for example via a network 106 (or by means of a storage medium such as a memory card). This can also take place during operation (or at least when the vehicle 101 is with the user) since the control software 107 is updated over time to new versions, for example.

The control software 107 can, for example, be trained by means of machine learning (ML), i.e., the control software 107 implements one or more ML models 108 (or machine learning model), which is trained on the basis of training data, by the computer system 105 in this example. The computer system 105 thus implements an ML training algorithm for training the one or more ML models 108, which are used for object recognition (e.g., other road users), for example.

The vehicle 101 is at least partially automated. The control software 107 carries out one or more driving functions (e.g., fully autonomous driving) by ascertaining control actions for the vehicle (such as steering actions, braking actions, etc.) from input data 109 that are available to it and that contain information about the environment or from which it derives information about the environment, i.e., detects the traffic situation (such as by detecting other road users, e.g., other vehicles), and controlling components of the vehicle accordingly. The input data 109 are, for example, sensor data such as information obtained from a camera of the vehicle or via communication with other vehicles or external apparatuses on the roadside.

Driving functions of at least partially automated vehicles (level 1 to level 5) require ever greater complexity as the range of functions increases. The driving functions often have a modular design so that uncertainties accumulate along the corresponding processing chain (processing of sensor data to detect a traffic situation, assessing the traffic situation, planning by a planning module, ascertaining the control actions, etc.) and can ultimately lead to an incorrect decision. In the course of ISO 21448 Safety of the Intended Functionality (SOTIF), it becomes mandatory not only to exclude input/output errors (ISO 26262) but also to counteract functional deficiencies.

Planning methods, in particular set-based methods, can provide safety guarantees for the trajectories planned with them.

However, these safety guarantees are typically only valid if the underlying assumptions are fulfilled.

According to various embodiments, a control method is therefore provided, in which safety guarantees can be extended by monitoring the assumptions at runtime and taking appropriate countermeasures in the event of a violation, thus ascertaining a behavior of the robotic apparatus (e.g., of a vehicle) that fulfills a specific safety criterion (e.g., that a risk probability is below a maximum permissible risk probability) even if one or more specific assumptions are not fulfilled (or are fulfilled only with too low a probability).

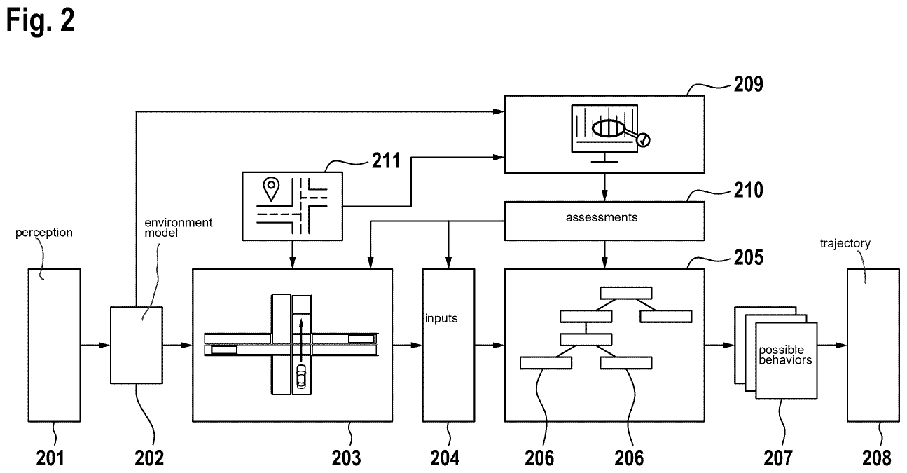

FIG. 2 illustrates an example of a control method according to one embodiment.

First, the vehicle (that is to be controlled, hereinafter accordingly referred to as the ego vehicle), for example its control unit 102, performs a perception 201 on the basis of the input data 109.

Typical sensor setups that serve as the basis for the perception 201 monitored by the method according to the present invention include mono cameras, stereo cameras, radar sensors, and/or LIDAR sensors. The use of ultrasonic sensors in extremely close range is also possible.

The result of the perception 201 is an environment model 202, which indicates, for example, where other road users are located (from the perspective of the ego vehicle). Therefrom and from information from a digital map of its environment, the control unit 102 in this exemplary embodiment creates a zone graph 203 using a (digital) map 211. It divides the environment of the ego vehicle into various zones, e.g., a close area of the ego vehicle, a more distant area of the ego vehicle, a stopping area, areas of a priority road (e.g., close to an intersection or further away) to which the ego vehicle comes, etc. These zones may be occupied by other road users. This information (occupancy of zones) is contained in the zone graph 203.

From the zone graph 203, the control unit ascertains inputs 204 for ascertaining, on the basis of a partial situation tree 205, partial situations 206 (leaves of the tree). For example, if a zone near an intersection to which the ego vehicle comes is occupied, the situation is different than if it is not occupied. The control unit follows the branches of the tree depending on the inputs 204, e.g., whether the vehicle reaches an intersection, whether a close area of the intersection is occupied, until it reaches leaves of the partial situation tree 205 and thus a partial situation. In doing so, it can also reach multiple partial situations 206 since, for example, both a close area and a far area of the intersection or both the lane on the left and the lane on the right can be occupied (i.e., there can be multiple paths through the partial situation tree 205 that are valid).

The current situation (traffic situation or, in general, control situation) is thus broken down into the partial situations 206. It then generates a set of boundary conditions for each partial situation 206. A set of boundary conditions defines one or more possible behaviors 207. For example, a partial situation is that another vehicle is near the intersection and has the right of way. In this case, the boundary condition is, for example, that the ego vehicle must yield the right of way to the other vehicle. Accordingly, the behavior is that the ego vehicle lets the other vehicle pass. There is leeway within this behavior: drive quickly to the intersection and stop, drive slowly to the intersection so that the ego vehicle does not have to stop, etc. Another behavior that also fulfills the boundary conditions could be that the ego vehicle crosses the intersection quickly. This behavior could be prioritized (the destination is reached faster) over the other behavior (stopping), but its risk is higher.

If the current traffic situation has been broken down into multiple partial situations 206, the boundary conditions generated for the individual partial situations 206 can be combined (i.e., they must all be taken into account or the stricter boundary conditions must be met). In other words, the combination of the individual partial situations ultimately results in a list of behaviors 207 (which are typically prioritized, e.g., according to the shortest possible duration of the trip), wherein each behavior is described by a corresponding set of boundary conditions.

The control unit 102 then selects a behavior from the behaviors 207 (e.g., according to a prioritization or a risk assessment) and ascertains a trajectory 208 for the ego vehicle that corresponds to this behavior.

This is carried out such that, if a planned trajectory meets the boundary conditions of a partial situation, the trajectory is formally guaranteed to be safe with respect to the partial situation. The system co-design (SCODE) methodology can be used to formally guarantee the logical completeness of the modeling.

Several methods are available for planning a trajectory within a behavior. For example, a sampling-based method, an optimization-based method, or a graph search, such as a hybrid A* search, can be used. Alternatively, the trajectory planning can also be externalized. In this case, an external module plans trajectory candidates, which are then checked to see which behaviors they match. From the trajectory candidates, the trajectory that meets the boundary conditions of the highest-priority, fulfillable behavior is selected. If multiple trajectory candidates comply with this behavior, the trajectory that generates the lowest costs with respect to a suitable cost function is selected.

In particular, it may be provided that, if the strictest boundary conditions cannot be met, further sets of boundary conditions are additionally issued. The ego vehicle can fall back on these further sets in order to behave with respect to the partial situation in a way that is most appropriate for the partial situation. Each behavior is assigned a clearly defined set of assumptions under which the behavior is formally guaranteed to be safe. The further the ego vehicle has to degrade (i.e., has to give up stricter boundary conditions, i.e., has to extend its behavior), the stricter the assumptions that have to be fulfilled so that the formal safety guarantee continues to apply.

Example: An ego vehicle approaches a yield intersection and detects crossing traffic, which makes it impossible to pass through the intersection. As long as the vehicle can still stop at the stop line, only the assumptions about the physical model of the vehicle must be fulfilled and it must be assumed that no object was overlooked on the way to the stop line. However, if the vehicle can no longer comply with the right-of-way traffic rule because, for example, the crossing traffic was recognized too late due to a perception error, the formal safety guarantee only applies under the much stricter assumption that the crossing traffic behaves cooperatively.

Safety is thus only guaranteed if assumptions are fulfilled. However, the assumptions may not be justified. For example, another road user does not behave as expected (e.g., drives very dangerously and fast) or the perception in the ego vehicle makes errors, e.g., recognizes a dynamic object as a static object.

According to various embodiments, it is therefore provided not to simply postulate that the assumptions apply, but to continuously monitor and support or challenge them (e.g., by means of probabilistic methods and statistical evidence collected at runtime) and to ascertain accordingly the behavior of the ego vehicle (or the multiple possible behaviors of the ego vehicle) from which a selection is made (e.g., according to a prioritization).

Supporting/challenging the assumptions probabilistically (i.e., monitoring the validity of the assumptions) can be performed for all assumptions or some of the assumptions. For this purpose, consistency and/or plausibility tests 209, which provide assessments 210, are assigned to the assumptions considered (i.e., the assumptions whose validity is to be monitored). The assessments 210 contain, for example for each assumption, a probabilistic metric, i.e., an assessment which states how certain it is that the corresponding assumption is valid (i.e., is justified, i.e., is fulfilled). If, on the basis of the collected statistical evidence, the assumptions made (for a particular behavior) can be supported to such an extent that the (overall) probability that they are justified (e.g., as the sum of (risk) probabilities over the assumptions that they are not valid) falls below an acceptable limit, it is assumed that the behavior is (formally) safe. This safety guarantee is thus more reliable than one based on postulating that the assumptions apply. This procedure thus increases safety.

If it turns out that the assumptions are justified, nothing changes in comparison to the behavior without monitoring of the assumptions. Otherwise, an assumption degradation mechanism is carried out in order to achieve the required safety at the expense of a more conservative behavior.

For the assumption degradation mechanism, the assumptions are prioritized (e.g., similarly to the behaviors) (i.e., there is a ranking of the assumptions). The assumptions are now abandoned (e.g., subset-wise) along their priority (ranking) until the probability that the remaining assumptions (i.e., the remaining subset of the set of all assumptions) are violated (e.g., again as the sum of risk probabilities over the remaining assumptions) has fallen below the acceptable limit. The prioritization of the assumptions can be partial-situation-specific (i.e., “local”). Discarding an assumption thus only has a local effect on the boundary conditions (i.e., the one or more possible behaviors) that are generated for the corresponding partial situation. The boundary conditions become more restrictive due to the removal of assumptions.

Example: Merging onto a freeway. In this case, an assumption made could be that the road users on the main roadway behave cooperatively and leave a gap for the automated vehicle. The partial situation would allow both changing lanes and remaining in the acceleration lane if the residual risk is sufficiently low. However, if it is determined that the assumption of cooperativeness is violated, changing lanes is not allowed, i.e., the boundary conditions become more restrictive.

By degrading the assumptions (i.e., abandoning assumptions since the risk that they are not valid is too great), it can happen that the resulting behaviors are so restrictive that downstream planning can no longer find a trajectory that fulfills the behavior. In this case, a fallback behavior can be used. This behavior then has at least the worst-case safety guarantees of the fallback behavior. Normally, if the assumptions are justified, an extended safety guarantee can be given.

The procedure described above can also improve driving performance. It should be noted that, if safety is to be guaranteed, the assumptions must be valid in every possible instance of the corresponding partial situation. Accordingly, the assumptions must be designed to be conservative. In contrast, the procedure described above allows for more detailed modeling, with some of the assumptions only being justified in certain situations. As a result, a less restrictive model can be selected in these cases, which leads to weaker boundary conditions and thus more leeway for optimization in the trajectory planning. This results in improved driving performance in these situations.

Example: For a situation S, there is an optimistic assumption Aₒₚₜ and a pessimistic assumption Aₚₑₛ. It is assumed that both S⇒Aₒₚₜ and S⇒Aₚₑₛ apply. It is then determined that S⇒Aₒₚₜ is generally not true. In this case, only S⇒Aₚₑₛ still applies, and the driving performance in S decreases according to the more restrictive boundary conditions. However, if there is sufficient statistical evidence that S can be divided into S₁ and S₂, wherein S₁⇒Aₒₚₜ applies, better driving performance can again be achieved for S₁.

In particular, the monitoring of predictions for other road users is suitable as part of the monitoring of the validity of assumptions (hereinafter also referred to as “assumption monitoring” for the sake of simplicity).

The monitoring of the validity of assumptions (that underlie the various behaviors) can be carried out by means of situation-specific monitoring methods (or tools), the result H of which is used as input to the models of the partial situations, i.e., to the algorithms with which the possible behaviors 207 are ascertained for the partial situations 206 (i.e., which perform the behavior ascertainment process). This shifts an assessment of the predictions to the assumption monitoring, while the model for the partial situations 206 itself remains unaffected. This separation of the models from, for example, assessments of the perceived state of the other road user (in the case that assumption monitoring includes monitoring of assumptions about the behavior of other road users) allows for an ideal data-based balancing of safety and performance in a situation.

For example, at an intersection where the ego vehicle has priority over another road user, it is expected that the other road user will yield the right of way to the ego vehicle. With a suitable monitoring tool (or “monitor”), it is now possible to monitor whether the other road user is adhering to these rules or not. This monitoring tool uses internal probabilistic models of the driving behavior based on the current state of the other road user. The monitoring tool then provides a statement for a particular partial situation about the validity of the assumption that the other road user yields the right of way to the ego vehicle. This statement (e.g., in the form of a risk probability) is included in the model of the partial situation so that it is taken into account when ascertaining possible behaviors.

Through the monitoring tool and its specific evaluation model, which may take into account features of the other road user that do not occur in the (superordinate) model of the partial situation, special features of specific road users can be taken into account, for example. This allows flexible adaptation of the more general partial situation to specific road users, which generally makes better safety and performance of the ego vehicle possible.

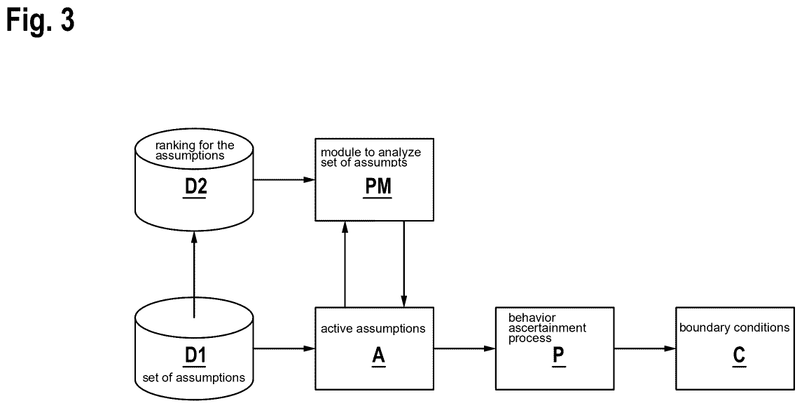

FIG. 3 shows a diagram 300 illustrating the ascertainment of behaviors with monitoring of the validity of assumptions.

The branch (D1, A, P, C) represents a process that, for given assumptions, generates boundary conditions (and thus one or more behaviors) C that guarantee safety if the assumptions are not violated. To this end, elements (D2, PM) are now added, which make it possible for the active assumptions A (i.e., the assumptions whose validity is assumed; they are part of all assumptions from the set of assumptions D1) to be adapted to the situation in an explainable process and based on static analyses, so that the safety logic established in the behavior ascertainment process P continues to function.

D2 defines a degradation logic and a real-time verification logic for the set of the assumptions D1. PM is a module that analyzes the set of assumptions DI for the behavior ascertainment process P and can adapt them before they are incorporated as active assumptions A into the behavior ascertainment process P. For example, the P module PM uses a map of the environment of the vehicle and an environment module as input. Real-time (or online) verification logic here refers to a logic that defines how the validity of the assumptions D1 is verified based on probabilistic analyses and describes the degradation logic, under which conditions which assumption is used as an active assumption (i.e., ultimately, which subset of the set of the original set of assumptions is used as active assumptions). For example, an assumption is used as an active assumption if a corresponding threshold value (defined in D2) is not exceeded by a risk probability (that the assumption does not apply).

D2 defines a ranking (order) for the assumptions in the set of assumptions D1 so that it is ensured that the module PM knows which assumption is more conservative and which is more progressive. The module PM is constructed according to a safety logic so that the adapted set of assumptions, i.e., the active assumptions A, as a result of the processing by P, lead to boundary conditions C that ensure safety.

The validity of an assumption can be assessed through a probabilistic reliability measure. An example of this is subjective logic. However, an application of the Dempster-Shafer theory or Bayesian inference is also possible. More generally, assessments could be used that increase monotonically with increasing estimated confidence (e.g., regarding a prediction and/or perception (e.g., object recognition)) and decrease accordingly when contradictory statistical evidence is measured.

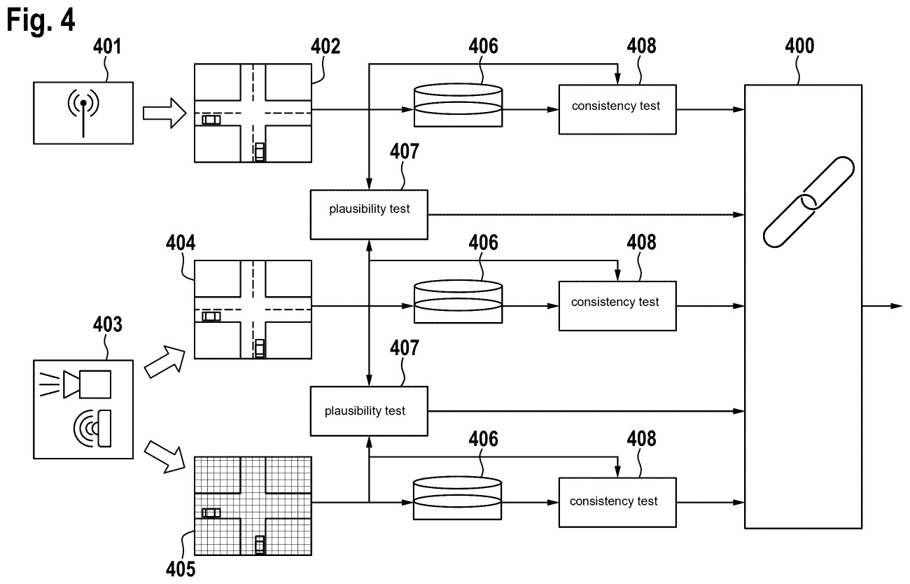

FIG. 4 illustrates a perception test performed by the ego vehicle. On the basis of such a test, the validity of assumptions based on the perception can be checked. For example, if an assumption is that no other road user is coming from the right, its validity can be assessed based on an assessment of the reliability of the perception.

In this example, a first object list 402 is created (for each acquisition time) from a first part of the input data 401 (e.g., V2X (vehicle-to-everything) communication data), and a second object list 404 and an occupancy of a map grid 405 of the environment of the vehicle to be controlled (also referred to as ego vehicle, e.g., vehicle 101) are ascertained from a second part of the input data 403 (e.g., sensor data). These perception results are stored in corresponding memories (or memory areas) 406, and the perception results over multiple acquisition times (e.g., over a certain time window) are used to perform plausibility tests 407 and consistency tests 408 (e.g., by comparing the different perception results 402, 404, 405). According to one embodiment, the results of the tests 407, 408 (analysis results) are subjective logic opinions and, in this case, are fused by means of a fusion operator 400 in order to obtain a subjective logic opinion for the reliability of the perception (i.e., the collected statistical evidence is presented in the form of subjective logic opinions and is summarized by means of one or more suitable fusion operators to form an overall result for the reliability of the perception). The perception test thus checks common assumptions and the specification of the perception and ascertains a probabilistic measure of the reliability with which the assumptions and specifications have been fulfilled. For example, a planning module typically assumes that the object lists 402, 404 (at least if they have been filtered over time over multiple acquisition times) do not contain any ghost objects (false positive objects) and that objects are not permanently overlooked (false negative objects). Planning modules typically also assume that neither false-positive occupancies (clutter) nor false-negative occupancies (overlooked occupancy) (of cells of the grid map 405) occur in the grid map 405 (grid) over multiple time steps. In order to measure the degree to which these assumptions are fulfilled, the perception test checks the object lists 402, 404 and the grid map 405 with the various consistency and plausibility tests 407, 408. According to one embodiment, these tests are supplemented by one or more consistency and plausibility tests based on a comparison with the digital map.

In detail, the vehicle perception generates an environment representation, which is represented by the second object list 404 and the occupancy of the cells of the grid map 405, from the sensor data 403 of the vehicle sensor system. Alternatively, it would also be possible to use only an object list or only an occupancy grid map. If available, the vehicle receives additional information about the vehicle environment via vehicle-to-anything (V2X) interface. In many cases, the received V2X data are cooperative perception messages (CPMs), each of which can be converted into an object list (in FIG. 4, the first object list 402). Object lists represent other road users in the form of so-called objects, which represent the dynamic state, the extents and, in many cases, the type of the corresponding road user. In addition, there is typically a residual class for unknown objects, such as a sack that has fallen from a truck onto the road.

The object lists 402, 404 are now checked for consistency in a first step (consistency tests 408). For this purpose, the object lists are temporarily stored for at least one time step (N≥1). On the basis of the past states, the movement of the objects is then predicted by means of a dynamic model, and the object lists 402, 404 of the N following time steps are used to check whether they are in the expected area. If this is the case, this is statistical evidence for the consistency of the object lists and thus for their reliability. If objects from subsequent time steps cannot be assigned, it is first checked whether there is another plausible explanation. For example, objects that move out of the field of view of the ego vehicle cannot be assigned for a reason. Objects that can neither be assigned nor filtered out by means of rules represent statistical evidence against the reliability of the corresponding object list. For example, the statistical evidence is converted into a binomial subjective logic opinion according to the following formula:

$$ω ( b , d , u , a ) = ( \frac{B}{B + D + 2} , \frac{D}{B + D + 2} , \frac{2}{B + D + 2} , a ) .$$

Here, ω is the binomial subjective logic opinion, b is the so-called belief measure, d is the so-called disbelief measure, u is the statistical uncertainty, and a is the a-priori distribution. In many cases, a=0.5 is chosen. B and D is the set of the corresponding statistical evidence for and against, respectively, the reliability of the system with respect to the aspect of object list consistency. In the simplest case, B is the number of successful associations and D is the number of objects that can be neither associated nor explained by filter rules. However, in many applications, the pure number is weighted by a factor.

Analogously, the consistency check is carried out on the basis of the grid map 405 for N time steps. This can be carried out such that not only a pars-pro-toto statement but also a spatial resolution in the form of a further grid map is provided.

Furthermore, the plausibility tests 407 are performed. For this purpose, the second object list 404 is compared with the first object list of the V2X data and with the grid map 405. According to one embodiment, the plausibility check between the grid map 406 and the object list 402, 404 is carried out in two directions. First, the extent of the objects is increased by a margin, and it is checked whether a plausible number of grid map cells are occupied within these extents. If this is the case, this provides statistical evidence for the reliability of the perception. Otherwise, statistical evidence against it. With this plausibility check, the particular object list 402, 404 is checked for false-positive objects and the grid map 405 is checked for cells with false-negative occupancy.

Conversely, the occupied cells that cannot be explained by objects are clustered. The remaining clusters are filtered by means of a digital map since off-street occupancies can be explained by static objects such as houses, curbs, trees, etc. The expectation is that no clusters of occupied cells remain on the roadway. If this is the case, this provides statistical evidence (for the current acquisition time) for the reliability of the perception with regard to the plausibility of the grid map 405 and the object lists 402, 404. Otherwise, each remaining cluster provides statistical evidence against the reliability. This plausibility check tests the object list for false-negative (i.e., overlooked) objects and the grid map 405 for cells with false-positive occupancy (clutter).

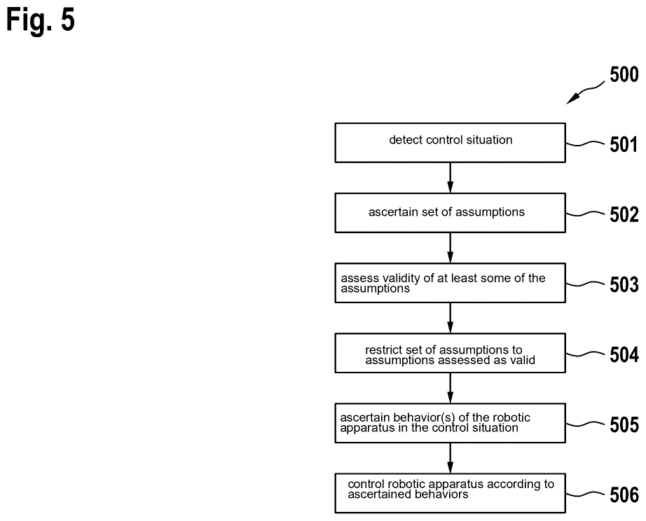

In summary, according to various embodiments, a method is provided as shown in FIG. 5.

FIG. 5 is a flowchart 500 illustrating a method for controlling a robotic apparatus.

A control situation is detected in 501. In particular, for example, a perception for recognizing other agents (such as other road users) in the control situation is performed. In other words, the control situation is recognized and can also be assessed, e.g., by means of a zone graph.

In 502, a set of assumptions about the control situation that underlie possible behaviors in the control situation (e.g., they are predefined for each of the possible behaviors) is ascertained.

In 503, the validity of at least some of the assumptions from the set of assumptions is assessed.

In 504, the set of assumptions is restricted to assumptions from the set of assumptions that have been assessed as valid.

In 505, one or more behaviors of the robotic apparatus in the control situation are ascertained on the basis of the restricted set of assumptions (i.e., the behaviors that are ascertained are those that are based on assumptions that have been assessed as valid).

In 506, the robotic apparatus is controlled according to one of the ascertained behaviors.

The method of FIG. 5 can be performed by one or more computers with one or more data processing units. The term “data processing unit” may be understood as any type of entity that allows for processing of data or signals. The data or signals can be treated, for example, according to at least one (i.e., one or more than one) special function which is performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA), or any combination thereof. Any other way of implementing the particular functions described in more detail herein may also be understood as a data processing unit or logic circuit assembly. One or more of the method steps described in detail here can be executed (e.g., implemented) by a data processing unit by one or more special functions that are performed by the data processing unit.

The method is therefore in particular computer-implemented according to various embodiments.

The approach of FIG. 5 is used to generate a control signal for a robotic apparatus. The term “robotic apparatus” may be understood to mean any technical system (comprising a mechanical part whose movement is controlled), such as a computer-controlled machine, a vehicle, a household appliance, a power tool, a manufacturing machine, a personal assistant, or an access control system.

Various embodiments may receive and use sensor signals from various sensors, such as video, radar, LIDAR, ultrasound, motion, thermal imaging, etc., for example in order to detect a corresponding control situation. The sensor data can be processed. This can comprise the classification of the sensor data or the performance of a semantic segmentation of the sensor data, for example in order to detect the presence of objects (in the environment in which the sensor data were obtained).

What is claimed is:

1. A method for controlling a robotic apparatus, comprising the following steps:
detecting a control situation;
ascertaining a set of assumptions about the control situation that underlie possible behaviors in the control situation;
assessing a validity of at least some of the assumptions from the set of assumptions;
restricting the set of assumptions to assumptions from the set of assumptions that have been assessed as valid;
ascertaining one or more behaviors of the robotic apparatus in the control situation based on the restricted set of assumptions; and
controlling the robotic apparatus according to one of the ascertained behaviors.

2. The method according to claim 1, wherein at least one of the assumptions from the set of assumptions is an assumption about a behavior of another agent in the control situation.

3. The method according to claim 1, wherein at least one of the assumptions from the set of assumptions is an assumption about a reliability of the detection of the control situation.

4. The method according to claim 1, further comprising:
ascertaining a ranking of subsets of the set of assumptions, wherein, when at least one assumption from a first of the subsets has been assessed as invalid, validity of the assumptions of one or more second of the subsets is assessed in an order given by the ranking, until a second subset of the set of assumptions has been found that contains only assumptions that have been assessed as valid.

5. The method according to claim 1, wherein the ascertaining of the validity of the at least some of the assumptions includes ascertaining a probabilistic measure that each assumption is valid, and the assumption is assessed as valid when the probabilistic measure exceeds a specified threshold value.

6. The method according to claim 5, wherein the probabilistic measure is a subjective logic opinion or a belief measure according to the Dempster-Shafer theory or a probability.

7. The method according to claim 1, wherein the robotic apparatus is a vehicle, and the control situation is a traffic situation.

8. A non-transitory computer-readable medium on which are stored commands for controlling a robotic apparatus, the commands, when executed by a processor, causing the processor to perform the following steps:
detecting a control situation;
ascertaining a set of assumptions about the control situation that underlie possible behaviors in the control situation;
assessing a validity of at least some of the assumptions from the set of assumptions;
restricting the set of assumptions to assumptions from the set of assumptions that have been assessed as valid;
ascertaining one or more behaviors of the robotic apparatus in the control situation based on the restricted set of assumptions; and
controlling the robotic apparatus according to one of the ascertained behaviors.
